(19) United States
(12) Patent Application Publication
(10) Pub. No.: US 2026/0064633 A1
(43) Pub. Date: Mar. 5, 2026

(54) COMPUTER-BASED PLATFORMS/SYSTEMS/DEVICES/COMPONENTS AND/OR OBJECTS CONFIGURED FOR GENERATING VALUES FOR DATA STRUCTURES AND METHODS OF USE THEREOF

(71) Applicant: Capital One Services, LLC, McLean, VA (US)

(72) Inventors: Saman Baghestani, Dallas, TX (US); Daniel Robert Sapp, McLean, VA (US); Roshni Rao, Frisco, TX (US); Bryan Parker, Richardson, TX (US); Jonathan Ricklis, Richardson, TX (US); Nidhi Pandya, McLean, VA (US); James Stephens, McLean, VA (US); Isaac Gonzalez, McLean, VA (US); Bharath Chekuri, Aubrey, TX (US)

(21) Appl. No.: 18/824,375

(22) Filed: Sep. 4, 2024

(51) Int. Cl. G06F 16/13; G06F 16/11

(52) U.S. Cl. CPC G06F 16/13; G06F 16/116

(57) ABSTRACT

Systems and methods of the present disclosure enable a processor to receive at least one proposed file structure and input the at least one proposed file structure into an instant structure generation model that generates unique candidate file structures. The processor may access accepted historical file structures and input the unique candidate file structures and the accepted historical file structures into at least one structure similarity machine learning model to output a subset of unique candidate file structures. The processor may display a list of the subset of unique candidate file structures via a graphical user interface that includes a one-click action element for each unique candidate file structure.

### FIELD OF TECHNOLOGY

The present disclosure generally relates to computer-based platforms/systems, improved computing devices/components and/or improved computing objects configured for generating combinations of values for populating data structures via machine learning models.

### BACKGROUND OF TECHNOLOGY

When a salesperson is negotiating a deal with a customer that involves a loan they may inadvertently propose terms that will ultimately be rejected by the lender, causing frustration for all parties involved. Such documents may be complex structures with many possible values making it difficult to determine based on the values alone whether a document will be approved. Only presenting a set of terms that has been previously accepted by the lender may avoid this issue, but at the cost of significantly reducing the flexibility available for the salesperson and customer. The ability to quickly propose, evaluate, and modify a loan structure that is likely to be accepted by the lender is an asset to all parties to the transaction.

### SUMMARY

In some embodiments, the present disclosure provides an exemplary technically improved computer-based method that includes at least the following steps of (i) receiving, by at least one processor, at least one proposed file structure, where the at least one proposed file structure includes a plurality of fields having a plurality of proposed values, (ii) inputting, by the at least one processor, the at least one proposed file structure into an instant structure generation model configured to (a) generate a plurality of proposed value variations by varying each proposed value of the plurality of proposed values within a threshold value range of each field of the plurality of fields and (b) generate a plurality of unique candidate file structures based on each combination of the plurality of proposed value variations, (iii) accessing, by the at least one processor, a plurality of accepted historical file structures, each accepted historical file structure including the plurality of fields having a plurality of accepted historical values, (iv) inputting, by the at least one processor, the plurality of unique candidate file structures and the plurality of accepted historical file structures into at least one structure similarity machine learning model to output a subset of unique candidate file structures based at least in part on (a) a similarity of the plurality of proposed value variations of each unique candidate file structure to the plurality of fields having a plurality of accepted historical values of each accepted historical file structure and (b) trained structure similarity machine learning model parameters, (v) displaying, by the at least one processor, a list of the subset of unique candidate file structures via a graphical user interface, where the graphical user interface includes a one-click action element for each unique candidate file structure, where the one-click action element is configured to, upon a selection of the one-click action element for a particular unique candidate file structure, cause the at least one processor to generate a particular document based at least in part on the particular unique candidate file structure.

In some embodiments, the present disclosure provides an exemplary technically improved computer-based method that includes at least the following steps (i) training, by at least one processor, an instant structure generation model to generate a plurality of unique candidate file structures by (a) configuring the instant structure generation model to receive as input a candidate file structure that includes a plurality of fields having a plurality of proposed values and return as output the plurality of unique candidate file structures with a plurality of proposed value variations and (b) inputting as training data, by the at least one processor, a plurality of accepted historical file structures into the instant structure generation model, where each accepted historical file structure includes the plurality of fields having at least one historical value, (ii) receiving, by at least one processor, the candidate file structure, (iii) providing, by the at least one processor, the candidate file structure to the trained instant structure generation model, and (iv) receiving, by the at least one processor, the plurality of unique candidate file structures as output from the trained instant structure generation model.

In some embodiments, the present disclosure provides an exemplary technically improved computer-based system that includes at least the following components of at least one processor in communication with at least one computer readable storage medium having software instructions stored thereon, where the software instructions, when executed, cause the at least one processor to perform steps to: (i) receive, by at least one processor, at least one proposed file structure, where the at least one proposed file structure includes a plurality of fields having a plurality of proposed values, (ii) input, by the at least one processor, the at least one proposed file structure into an instant structure generation model configured to (a) generate a plurality of proposed value variations by varying each proposed value of the plurality of proposed values within a threshold value range of each field of the plurality of fields and (b) generate a plurality of unique candidate file structures based on each combination of the plurality of proposed value variations, (iii) access, by the at least one processor, a plurality of accepted historical file structures, each accepted historical file structure including the plurality of fields having a plurality of accepted historical values, (iv) input, by the at least one processor, the plurality of unique candidate file structures and the plurality of accepted historical file structures into at least one structure similarity machine learning model to output a subset of unique candidate file structures based at least in part on (a) a similarity of the plurality of proposed value variations of each unique candidate file structure to the plurality of fields having a plurality of accepted historical values of each accepted historical file structure and (b) trained structure similarity machine learning model parameters, (v) display, by the at least one processor, a list of the subset of unique candidate file structures via a graphical user interface, where the graphical user interface includes a one-click action element for each unique candidate file structure, where the one-click action element is configured to, upon a selection of the one-click action element for a particular unique candidate file structure, cause the at least one processor to generate a particular document based at least in part on the particular unique candidate file structure.

### BRIEF DESCRIPTION OF THE DRAWINGS

Various embodiments of the present disclosure can be further explained with reference to the attached drawings, where like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a flow diagram of an exemplary method for generating values for data structures in accordance with one or more embodiments of the present disclosure.

FIG. 2 depicts a block diagram of an exemplary system for generating values for data structures in accordance with one or more embodiments of the present disclosure.

FIG. 3 depicts a flow diagram of an exemplary method for generating values for data structures in accordance with one or more embodiments of the present disclosure.

FIG. 4 depicts a block diagram of an exemplary computer-based system and platform for generating values for data structures in accordance with one or more embodiments of the present disclosure.

FIG. 5 depicts a block diagram of another exemplary computer-based system and platform for generating values for data structures in accordance with one or more embodiments of the present disclosure.

FIG. 6 depicts illustrative schematics of an exemplary implementation of the cloud computing/architecture(s) in which embodiments of a system for generating values for data structures may be specifically configured to operate in accordance with some embodiments of the present disclosure.

FIG. 7 depicts illustrative schematics of another exemplary implementation of the cloud computing/architecture(s) in which embodiments of a system for generating values for data structures may be specifically configured to operate in accordance with some embodiments of the present disclosure.

### DETAILED DESCRIPTION

Various detailed embodiments of the present disclosure, taken in conjunction with the accompanying FIGs., are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

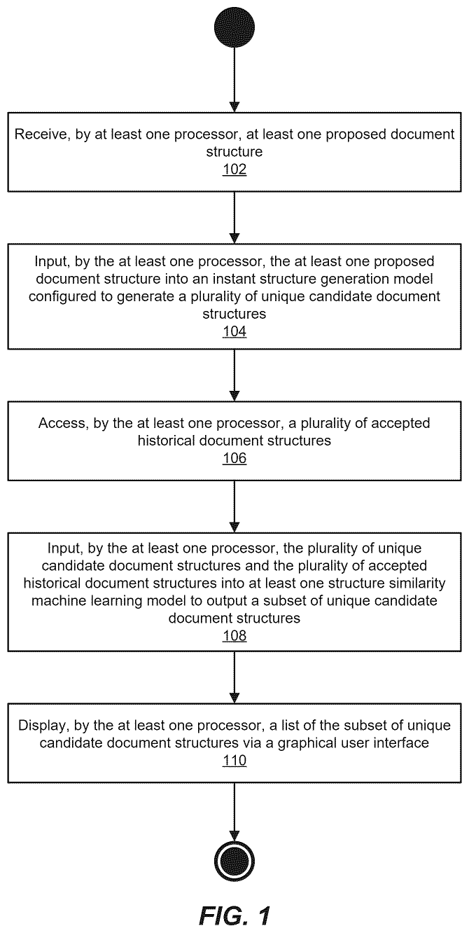

FIGS. 1 through 7 illustrate systems and methods of generating candidate documents (e.g., contracts, loan agreements, specification documents, etc.) via machine learning algorithms trained on previous documents of the same general type and configured to produce candidate documents with varied values based on at least one input value. The following embodiments provide technical solutions and technical improvements that overcome technical problems, drawbacks and/or deficiencies in the technical fields involving specialized document generation, machine learning and/or user interface design. As explained in more detail, below, technical solutions and technical improvements herein include aspects of improved specialized document generation by improved training techniques for machine learning for automatically generating documents based on values input by the user and training data from previously accepted documents, so as to both maximize similarity to the user inputs while minimizing a probability of generating documents that will later be rejected for failing to meet various types of specifications (e.g., loan terms), and building a custom user interface to support user interaction with such capabilities. Based on such technical features, further technical benefits become available to users and operators of these systems and methods. Moreover, various practical applications of the disclosed technology are also described, which provide further practical benefits to users and operators that are also new and useful improvements in the art.

FIG. 1 illustrates a flowchart of an illustrative methodology in accordance with one or more embodiments of the present disclosure. As illustrated in FIG. 1, at step 102, at least one processor may receive at least one proposed file structure. In some embodiments, a file structure may be and/or contain a document structure and/or other digital representation of a document. In some embodiments, the at least one proposed file structure is a data structure, such as a table, array, vector, list, object, application programming interface (API) call, or other data structure representative of a proposed document. In some embodiments, the at least one proposed file structure may be provided, e.g., by a user to another user, as a proposed structure for, e.g., an agreement, contract, product specification, design specification, programming parameters (e.g., for an API, HTML document, script, etc.), or any other suitable structure or any combination thereof. Thus, in some embodiments, the at least one proposed file structure signifies a proposal for the structure of a particular item that is subject to compatibility with one or more restrictions of one or more parties and/or technical/computing systems.

In some embodiments, the at least one proposed file structure may include a plurality of fields having a plurality of proposed values. In some examples, the proposed file structure may include a document structure for a contract, such as a purchase contract, and/or the proposed values may include numerical values such as dates, timespans, and/or monetary amounts. For example, the proposed file structure may be a proposed automotive purchase contract or other purchase contract with fields such as purchase price, trade-in value, loan term, loan interest rate, loan amount, monthly payment, and so forth. In one example, the proposed file structure may be a proposed purchase contract with one or more values specified by a user who is a party to the proposed contract. For example, the user may specify a purchase price and/or loan term. In some examples, some fields may have values that are not numerical, such as the make and/or model of a car.

In one example, a dealer's financing representative may be trying to create an automotive purchase deal that works for a customer. The representative may set values for fields such as sales price, money down, tax, title, license, etc. Depending on capital, the lender's credit policy, and so forth, any of these values being out of the lender's accepted range or a combination of them can bring a deal out of policy for the lender and result in the deal being denied. For example, the total amount that the customer will need to finance being a specific multiplier with respect to the car's book value or the warranty being over a certain percentage of its book value may result in denial. In some examples, the representative may input a proposed file structure that is out of policy to the systems described herein and the systems described herein may generate a plurality of candidate file structures that are similar to the proposed file structure but are in policy and thus likely to be accepted by the lender. Additionally, or alternatively, the representative may input a single target value within the proposed structure, such as monthly payment, and the systems described herein may generate candidate file structures with the target monthly payment.

In another example, a bank representative may be evaluating a home loan application and attempting different variations of duration, interest rate, points, and so forth, relative to the total value of the loan and/or the appraised value of the home. Additional examples of file structures may include, without limitation, contracts of all types, agreements, proposed specifications and/or design requirements.

At step 104, at least one processor may input the at least one proposed file structure into an instant structure generation model configured to generate a plurality of unique candidate file structures. In some embodiments, the instant structure generation model may generate a plurality of proposed value variations by varying each proposed value of the plurality of proposed values within a threshold value range of each field of the plurality of fields and generate a plurality of unique candidate file structures based on each combination of the plurality of proposed value variations. For example, the instant structure generation model may vary the values of the loan amount, loan duration, monthly payment, and/or interest rate to generate new candidate file structures. The instant structure generation model may generate proposed value variations in a variety of ways. For example, the model may increment or decrement a value by an amount from a list or range of set amounts (e.g., by one, by two, by three, by ten, by one hundred, etc.). In another example, the model may select a random number within a range, either via a random distribution or a weighted distribution (e.g., a bell curve). In some examples, the model may select a value from a predetermined list of value options. For example, a loan duration may have a predetermined list of values of six months, one year, eighteen months, two years, five years, or ten years and the model may not suggest a loan duration outside of that list (e.g., seven months, two years and three months, etc.), while a monthly payment may have a range of values at specific increments, such as a range from $300-900 at $20 increments.

In some embodiments, the instant structure generation model may constrain some values based at least in part on other values. For example, the model may constrain the loan duration based on the loan amount so that a loan with a low amount is not paired with a long duration (e.g., a two-thousand-dollar loan over a duration of ten years) and/or a loan with a high amount is not paired with a short duration. In another example, the model may calculate the monthly payment based off of the loan duration or vice versa rather than generating the values independently. In some embodiments, the model may constrain values for certain fields to fall within a predefined window, such as constraining a loan term to be between six months and ten years. In one embodiment, the model may retrieve external data and base the window for at least one value on this external data, such as retrieving the current federal interest rate and restricting the proposed interest rates to a window anchored to the federal interest rate. In some examples, the model may not vary the values of certain fields. For example, if one field is the make and model of a trade-in vehicle, the model may not vary this value. In some examples, the instant structure generation model may constrain some values based on ratios to other values. For example, if the structure is a purchase agreement for a car, the model may constrain the value of the warranty and/or other values as a ratio of the book value of the car.

At step 106, at least one processor may access a plurality of accepted historical file structures. In some embodiments, each accepted historical file structure may include the plurality of fields having a plurality of accepted historical values. For example, the accepted historical file structures may include previously drafted contracts for similar matters that were accepted by all parties involved. In one example, the accepted historical file structures may include accepted contracts to purchase vehicles that include purchase price, loan terms, and so forth. In one embodiment, the processor may retrieve the accepted historical file structures from a database operated by a lender that is party to the contracts. In some embodiments, the processor may additionally access a plurality of non-accepted historical file structures. For example, the non-accepted historical file structures may include previously drafted contracts for similar matters that were rejected by at least one party. In one example, a non-accepted historical file structure may include a vehicle contract that was rejected by the lender due to the terms of the loan not complying with the lender's policies.

At step 108, at least one processor may input the plurality of unique candidate file structures and the plurality of accepted historical file structures into at least one structure similarity machine learning model to output a subset of unique candidate file structures. In some embodiments, the model may rate a proposed file structure by the percentage that it would be classified as an accepted file structure instead of a non-accepted file structure. The structure similarity machine learning model may use a variety of machine learning algorithms. For example, the structure similarity machine learning model may use a tree-based model such as a random forest classifier to determine the subset of unique candidate file structures.

In one embodiment, the subset of unique candidate file structures may be based on a similarity of the plurality of proposed value variations of each unique candidate file structure to the plurality of fields having a plurality of accepted historical values of each accepted historical file structure and/or trained structure similarity machine learning model parameters. Additionally, or alternatively, the subset of unique candidate file structures may be based on a difference of the proposed value variations from the historical values in non-accepted historical file structures. In some embodiments, the structure similarity machine learning model may calculate a metric for each candidate file structure (e.g., similarity to the nearest accepted historical file structure, similarity to an average historical file structure, likelihood of being accepted, etc.) and may select the subset of candidate file structures based at least in part on this metric. For example, the model may order the candidate file structures by the metric and output only the top N candidate file structures (e.g., the top five, the top ten, etc.) and/or may exclusively output candidate file structures with a metric above a predetermined threshold (e.g., above 80%, above 90%, etc.).

At step 110, at least one processor may display a list of the subset of unique candidate file structures via a graphical user interface (GUI). In one embodiment, the GUI may include a one-click action element for each unique candidate file structure, where the one-click action element is configured to, upon a selection of the one-click action element for a particular unique candidate file structure, cause the at least one processor to generate a particular document based at least in part on the particular unique candidate file structure. In some embodiments, the GUI may display the candidate file structures ranked by and/or in conjunction with a metric calculated in step 108.

In some embodiments, the GUI may enable manual editing of the document generated by the one-click action element. For example, the GUI may enable a user to manually edit the values of one or more fields.

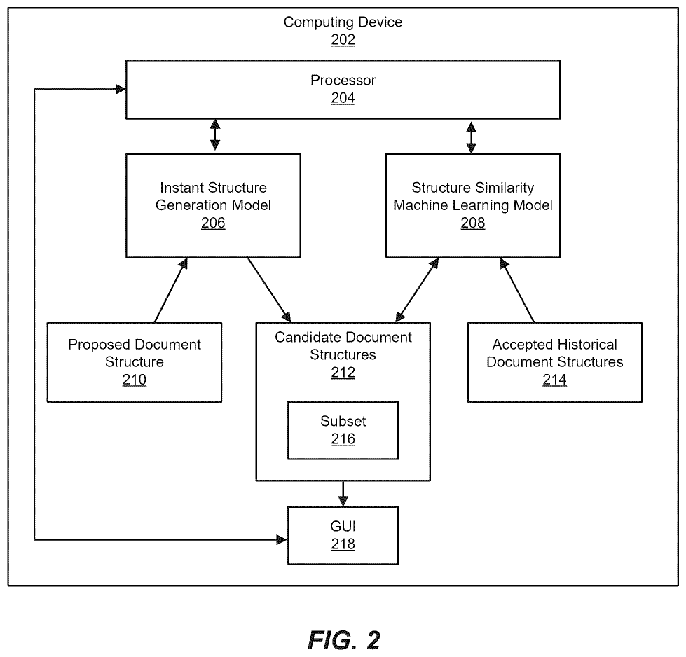

FIG. 2 is a block diagram of another exemplary computer-based system and platform for generating values for data structures in accordance with one or more embodiments of the present disclosure. As illustrated in FIG. 2, a computing device 202 may be configured with a processor 204. In one embodiment, processor 204 may receive at least one proposed file structure 210 and input proposed file structure 210 into an instant structure generation model 206 configured to generate a plurality of unique candidate file structures 212, as described in connection with steps 102 and 104 in FIG. 1. For example, processor 204 may receive a set of proposed terms for an automotive loan (e.g., any or all of a total loan amount, loan duration, monthly payment, interest rate, value of vehicle that is subject to the loan, etc.) and input the proposed terms into instant structure generation model 206 that has been trained to generate variations on automotive loan terms. In this example, computing device 202 may be an endpoint device (e.g., a personal computing device) that a user uses to input the proposed loan terms. Alternatively, computing device 202 may be a server that receives loan terms from an endpoint device operated by the user. Processor 204 may access a plurality of accepted historical file structures 214 and input unique candidate file structures 212 and accepted historical file structures 214 into at least one structure similarity machine learning model 208 to output a subset 216 of unique candidate file structures 212, as described in connection with steps 106 and 108 in FIG. 1. For example, processor 204 may access a database of accepted automotive loan terms and input the various suggested loan terms generated by instant structure generation model 206 into structure similarity learning model 208 that has been trained and/or configured to detect the similarity of proposed automotive loan agreements to accepted automotive loan agreements. Next, processor 204 may display a list of subset 216 via a GUI 218, as described in connection with step 110 in FIG. 1. For example, processor 204 may display a list of subset 216 via a dashboard that enables a user to view, modify, print, and/or approve a set of automotive loan terms.

In some embodiments, computing device 202 may be a server, cloud environment, or edge device such as a laptop, desktop computer, or mobile computing device (e.g., a smartphone, tablet, etc.) or any combination thereof. Although depicted as a single device, in some embodiments computing device 202 may be multiple devices (e.g., multiple cloud servers in communication with one another). In one embodiment, GUI 218 may be rendered on a display of a server terminal and/or edge device.

Examples of processor 204 may include any type of relevant processor or processors including microprocessors, single core processors, multi-core processor, or any other central processing unit. In various implementations, one or more instances of processor 204 may be dual-core processor(s), dual-core mobile processor(s), and so forth. Processor 204 may execute and/or implement instant structure generation model 206 and/or structure similarity machine learning model 208 using one or more corresponding computer engines. In some embodiments, the systems described herein may store proposed file structure 210, unique candidate file structures 212, and/or accepted historical file structures 214 locally, remotely, and/or via a hybrid local/remote storage scheme for access by instant structure generation model 206 and/or structure similarity machine learning model 208.

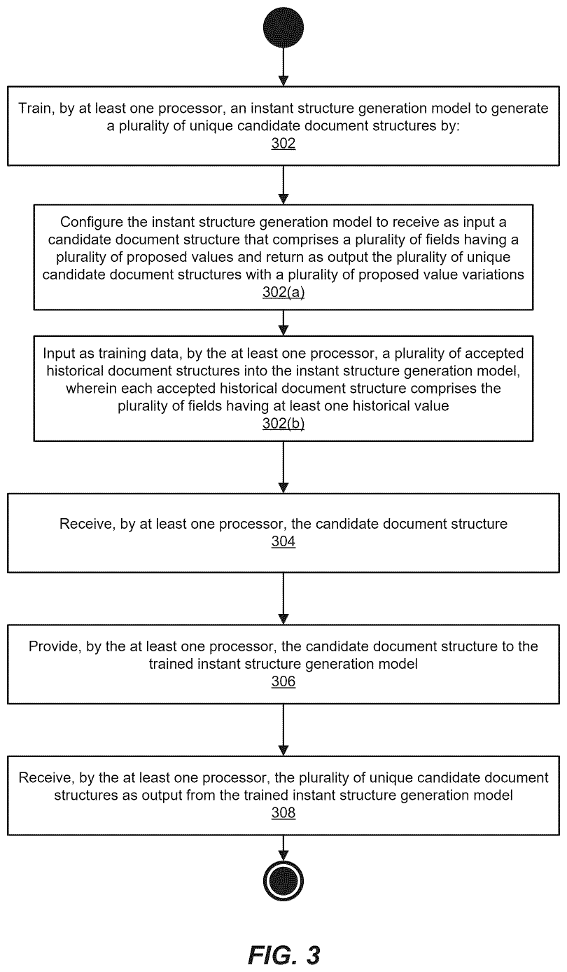

FIG. 3 illustrates a flowchart of an illustrative methodology in accordance with one or more embodiments of the present disclosure. As illustrated in FIG. 3, at step 302, at least one processor may train an instant structure generation model to generate a plurality of unique candidate file structures. For example, at step 302(a) the at least one processor may train the instant structure generation model by configuring the instant structure generation model to receive as input a candidate file structure that includes a plurality of fields having a plurality of proposed values and return as output the plurality of unique candidate file structures with a plurality of proposed value variations. At step 302(b), by inputting as training data a plurality of accepted historical file structures into the instant structure generation model, where each accepted historical file structure includes the plurality of fields having at least one historical value, the instant structure generation model may be trained according to the at least one historical value. Each value may represent an input feature for the instant structure generation model such that the instant structure generation model may be trained on the training data to model combinations of values for the fields of historical file structures in order to predict variations to proposed values that are likely to be accepted based on the historical accepted file structures.

For example, the training data may include, e.g., the values of field in an accepted file structure for, e.g., a loan such as an automotive loan, where the fields may include the loan amount, loan duration, monthly payment, and/or interest rate among others. Thus, the instant structure generation model may be trained on the training data of load file structures to model combinations of values for the fields of historical accepted loan file structures in order to predict variations to proposed values that are likely to be accepted.

In some embodiments, the processor may also input as training data rejected historical file structures. In these embodiments, the machine learning model may analyze the differences between accepted and rejected historical file structures to determine features that are likely to result in an accepted file structure.

At step 304, the at least on processor may receive the candidate file structure. At step 306, the at least one processor may provide the candidate file structure to the trained instant structure generation model. For example, the processor may receive a candidate file structure and provide the candidate file structure to the model as described in conjunction with FIG. 1 above.

In some embodiments, the parameters of the instant structure generation model may be trained based on known outputs. For example, the candidate file structure may be paired with a target value or known value to form a training pair, such as a historical candidate file structure and an observed result and/or human annotated value representing a data point in the relationship between the historical candidate file structure and historical value(s) of fields of the accepted candidate file structure. In some embodiments, the candidate file structure may be provided to the instant structure generation model, e.g., encoded in a feature vector, to produce a predicted output value. In some embodiments, an optimizer associated with the instant structure generation model may then compare the predicted output value with the known output of a training pair including the historical candidate file structure to determine an error of the predicted output value. In some embodiments, the optimizer may employ a loss function, such as, e.g., Hinge Loss, Multi-class SVM Loss, Cross Entropy Loss, Negative Log Likelihood, or other suitable classification loss function to determine the error of the predicted output value based on the known output.

In some embodiments, the known output may be obtained after the instant structure generation model produces the prediction, such as in online learning scenarios. In such a scenario, the instant structure generation model may receive the candidate file structure and generate the model output vector to produce an output value representing historical value(s) of fields of the accepted candidate file structure. Subsequently, a user may provide feedback by, e.g., modifying, adjusting, removing, and/or verifying the output value via a suitable feedback mechanism, such as a user interface device (e.g., keyboard, mouse, touch screen, user interface, or other interface mechanism of a user device or any suitable combination thereof). The feedback may be paired with the candidate file structure to form the training pair and the optimizer may determine an error of the predicted output value using the feedback.

In some embodiments, based on the error, the optimizer may update the parameters of the instant structure generation model using a suitable training algorithm such as, e.g., backpropagation for a prediction machine learning model. In some embodiments, backpropagation may include any suitable minimization algorithm such as a gradient method of the loss function with respect to the weights of the prediction machine learning model. Examples of suitable gradient methods include, e.g., stochastic gradient descent, batch gradient descent, mini-batch gradient descent, or other suitable gradient descent technique. As a result, the optimizer may update the parameters of the instant structure generation model based on the error of predicted labels in order to train the instant structure generation model to model the correlation between candidate file structure and historical value(s) of fields of the accepted candidate file structure in order to produce more accurate output values based on candidate file structure.

At step 306, the at least one processor may receive the plurality of unique candidate file structures as output from the trained instant structure generation model. For example, the processor may receive a set of candidate file structures that are ranked by probability of being accepted (e.g., by a lender evaluating a purchase agreement that includes a loan).

In some embodiments, the processor may cause display of the set of candidate documents on an endpoint device (e.g., laptop, tablet, desktop, smartphone, etc.). For example, the processor may generate a GUI that displays the set of candidate file structures. In one example, the GUI may display the full information about each candidate file structure, such as the list of fields and the values for each field. For example, the GUI e may display the terms of an automotive loan such as duration, monthly payment, total amount, interest rate, and so forth.

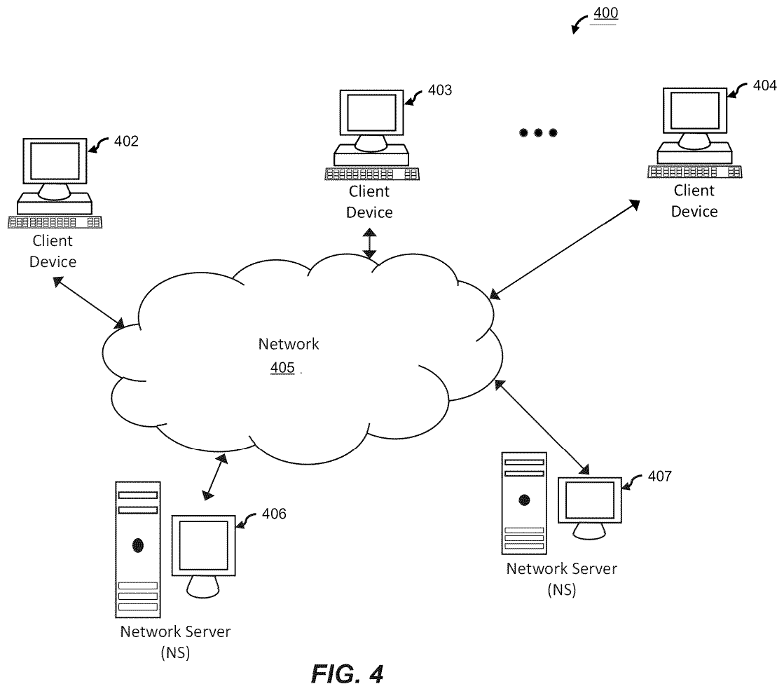

FIG. 4 depicts a block diagram of an exemplary computer-based system and platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 400 may be configured to manage a large number of members and concurrent transactions, as detailed herein. In some embodiments, the exemplary computer-based system and platform 400 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 4, client device 402, client device 403 through client device 404 (e.g., clients) of the exemplary computer-based system and platform 400 may include virtually any computing device capable of receiving and sending a message over a network (e.g., cloud network), such as network 405, to and from another computing device, such as servers 406 and 407, each other, and the like. In some embodiments, the client devices 402 through 404 may be personal computers, multiprocessor systems, microprocessor-based or programmable consumer electronics, network PCs, and the like. In some embodiments, one or more client devices within client devices 402 through 404 may include computing devices that typically connect using a wireless communications medium such as cell phones, smart phones, pagers, walkie talkies, radio frequency (RF) devices, infrared (IR) devices, EBs citizens band radio, integrated devices combining one or more of the preceding devices, or virtually any mobile computing device, and the like. In some embodiments, one or more client devices within client devices 402 through 404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more client devices within client devices 402 through 404 may include may run one or more applications, such as Internet browsers, mobile applications, voice calls, video games, videoconferencing, and email, among others. In some embodiments, one or more client devices within client devices 402 through 404 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a client device within client devices 402 through 404 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a client device may periodically report status or send alerts over text or email. In some embodiments, a client device may contain a data recorder which is remotely downloadable by the user using network protocols such as FTP, SSH, or other file transfer mechanisms. In some embodiments, a client device may provide several levels of user interface, for example, advance user, standard user. In some embodiments, one or more client devices within client devices 402 through 404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 405 may also include mass storage, such as network attached storage (NAS), a storage area network (SAN), a content delivery network (CDN) or other forms of computer or machine readable media.

In some embodiments, the exemplary server 406 or the exemplary server 407 may be a web server (or a series of servers) running a network operating system, examples of which may include but are not limited to Apache on Linux or Microsoft IIS (Internet Information Services). In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the client devices 401 through 404.

In some embodiments and, optionally, in combination of any embodiment described above or below, for example, one or more exemplary computing client devices 402 through 404, the exemplary server 406, and/or the exemplary server 407 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

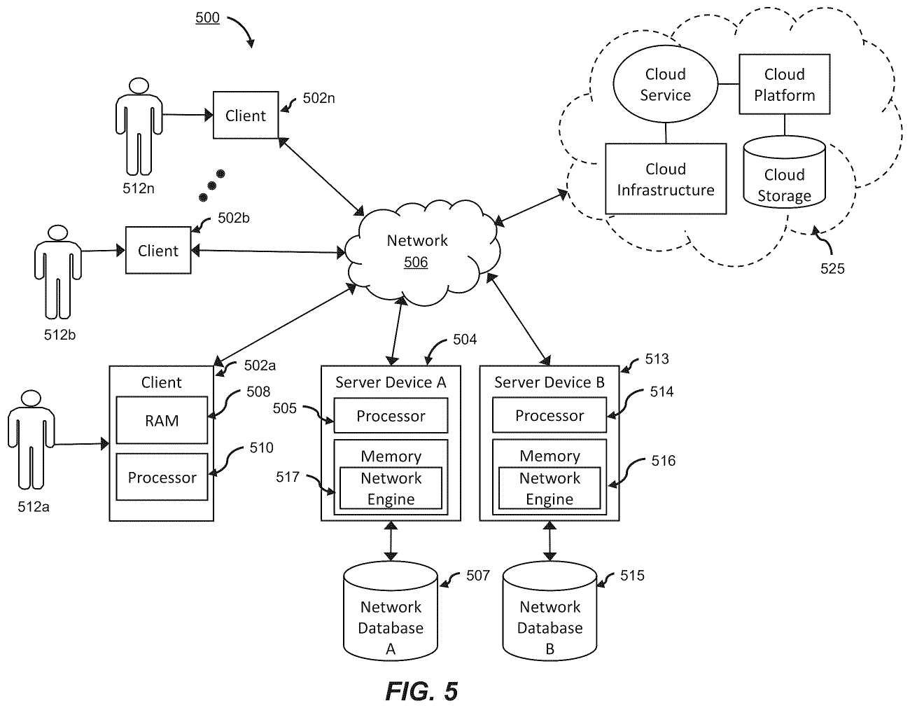

FIG. 5 depicts a block diagram of another exemplary computer-based system and platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the client device 502a, client device 502b through client device 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client device 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may include code from any computer-programming language, including, for example, C, C++, Visual Basic, Java, Python, Perl, JavaScript, and etc.

In some embodiments, client devices 502a through 502n may also include a number of external or internal devices such as a mouse, a CD-ROM, DVD, a physical or virtual keyboard, a display, or other input or output devices. In some embodiments, examples of client devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, client devices 502a through 502n may be specifically programmed with one or more application programs in accordance with one or more principles/methodologies detailed herein. In some embodiments, client devices 502a through 502n may operate on any operating system capable of supporting a browser or browser-enabled application, such as Microsoft™, Windows™, and/or Linux. In some embodiments, client devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, user 512a, user 512b through user 512n, may communicate over the exemplary network 506 with each other and/or with other systems and/or devices coupled to the network 506. As shown in FIG. 5, exemplary server devices 504 and 513 may include processor 505 and processor 514, respectively, as well as memory 517 and memory 516, respectively. In some embodiments, the server devices 504 and 513 may be also coupled to the network 506. In some embodiments, one or more client devices 502a through 502n may be mobile clients.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

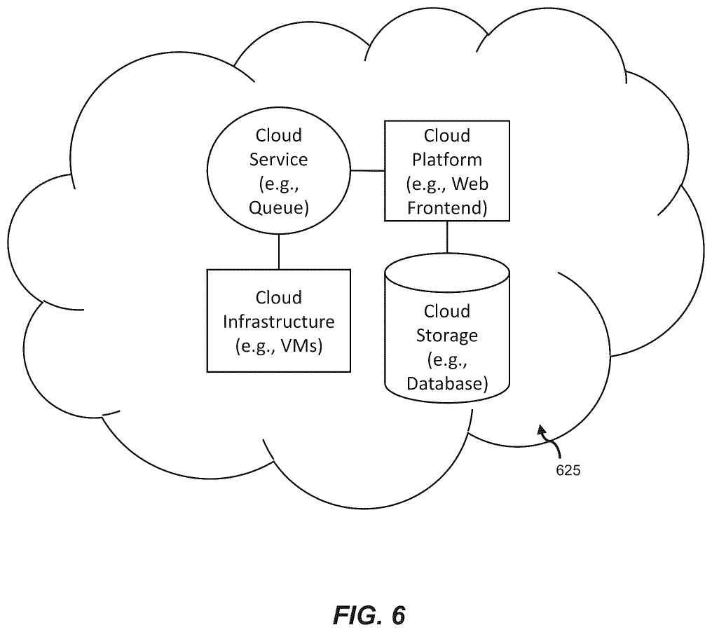

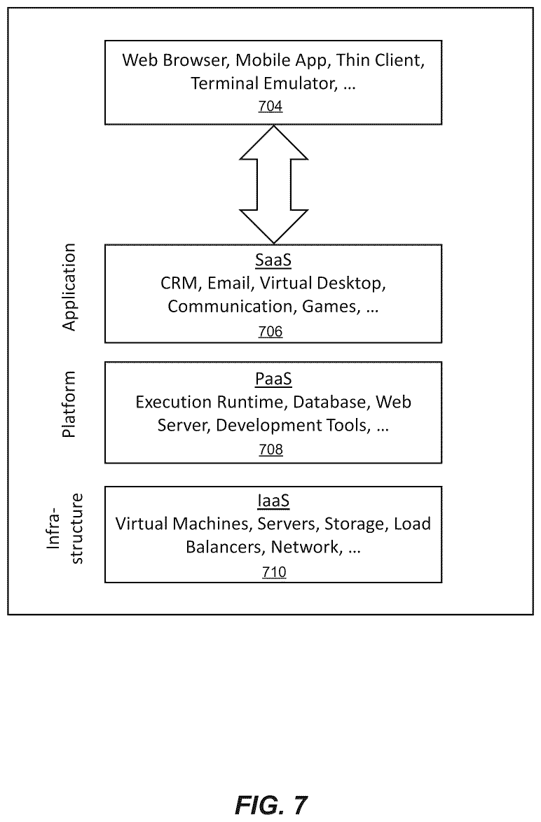

In some embodiments, the exemplary inventive computer-based systems/platforms, the exemplary inventive computer-based devices, and/or the exemplary inventive computer-based components of the present disclosure may be specifically configured to operate in a cloud computing/architecture 525 such as, but not limiting to: infrastructure a service (IaaS) 710, platform as a service (PaaS) 708, and/or software as a service (SaaS) 706 using a web browser, mobile app, thin client, terminal emulator or other endpoint 704. FIGS. 6 and 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; ×86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) Open VMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24).NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.

Clause 1: A method, including:
receiving, by at least one processor, at least one proposed file structure, where the at least one proposed file structure includes a plurality of fields having a plurality of proposed values;
inputting, by the at least one processor, the at least one proposed file structure into an instant structure generation model configured to:
   generate a plurality of proposed value variations by varying each proposed value of the plurality of proposed values within a threshold value range of each field of the plurality of fields; and
   generate a plurality of unique candidate file structures based on each combination of the plurality of proposed value variations;
accessing, by the at least one processor, a plurality of accepted historical file structures, each accepted historical file structure including the plurality of fields having a plurality of accepted historical values;
inputting, by the at least one processor, the plurality of unique candidate file structures and the plurality of accepted historical file structures into at least one structure similarity machine learning model to output a subset of unique candidate file structures based at least in part on:
   a similarity of the plurality of proposed value variations of each unique candidate file structure to the plurality of fields having a plurality of accepted historical values of each accepted historical file structure, and
   trained structure similarity machine learning model parameters;
displaying, by the at least one processor, a list of the subset of unique candidate file structures via a graphical user interface;
   where the graphical user interface includes a one-click action element for each unique candidate file structure;
   where the one-click action element is configured to, upon a selection of the one-click action element for a particular unique candidate file structure, cause the at least one processor to generate a particular document based at least in part on the particular unique candidate file structure.

2. The method of clause 1, where the displaying the list of the subset of unique candidate file structures includes:
determining, by the at least one processor, a similarity metric associated with each unique candidate file structure of the subset of unique candidate file structures based at least in part on the similarity of the plurality of proposed value variations of each unique candidate file structure;
ranking, by the at least one processor, the list of the subset of unique candidate file structures in an order from highest to lowest similarity to the accepted historical values of each accepted historical file structure based at least in part on the similarity metric associated with each unique candidate file structure; and
displaying, by the at least one processor, the list of the subset of unique candidate file structures in the order.

3. The method of clause 1, where the inputting the plurality of unique candidate file structures into the at least one structure similarity machine learning model to output the subset of unique candidate file structures includes:
calculating, by the at least one processor, for each of the unique candidate file structures, by the at least one structure similarity machine learning model, a percentage likelihood of the unique candidate file structure being accepted.

4. The method of clause 1, where the at least one structure similarity machine learning model includes a random forest classifier.

5. The method of clause 1, further including:
instructing, by the at least one processor, to display the user graphical interface that is configured to enable a manual editing of the particular document.

6. The method of clause 1, where the inputting the at least one proposed file structure into the instant structure generation model includes:
receiving, by the at least one processor, a preferred value for a specified field as input; and
generating, by the at least one processor using the instant structure generation model, the plurality of proposed value variations by varying each proposed value of the plurality of proposed values based at least in part on the preferred value for the specified field.

7. The method of clause 1, where the plurality of fields includes a plurality of data items identifying a valuation of a vehicle.

Clause 8: A method including:
training, by at least one processor, an instant structure generation model to generate a plurality of unique candidate file structures by:
   configuring the instant structure generation model to receive as input a candidate file structure that includes a plurality of fields having a plurality of proposed values and return as output the plurality of unique candidate file structures with a plurality of proposed value variations; and
   inputting as training data, by the at least one processor, a plurality of accepted historical file structures into the instant structure generation model, where each accepted historical file structure includes the plurality of fields having at least one historical value; receiving, by at least one processor, the candidate file structure;
providing, by the at least one processor, the candidate file structure to the trained instant structure generation model; and
receiving, by the at least one processor, the plurality of unique candidate file structures as output from the trained instant structure generation model.

9. The method of clause 8, where the inputting as training data, by the at least one processor, the plurality of accepted historical file structures into the instant structure generation model includes:
pre-processing, by the at least one processor, the plurality of accepted historical file structures into a format expected by the instant structure generation model.

10. The method of clause 8, where the configuring the instant structure generation model includes configuring the instant structure generation model to:
generate a plurality of proposed value variations by varying each proposed value of the plurality of proposed values within a threshold value range of each field of the plurality of fields; and
generate the plurality of unique candidate file structures based on each combination of the plurality of proposed value variations.

11. The method of clause 8, further including inputting, by the at least one processor, the plurality of unique candidate file structures into at least one structure similarity machine learning model to output a subset of unique candidate file structures based at least in part on:
a similarity of the plurality of proposed value variations of each unique candidate file structure to the plurality of fields having a plurality of accepted historical values of each accepted historical file structure; and
trained structure similarity machine learning model parameters.

12. The method of clause 8, further including displaying, by the at least one processor, a list of a subset of unique candidate file structures via a graphical user interface;
where the graphical user interface includes a one-click action element for each unique candidate file structure;
where selection of the one-click action element for a particular unique candidate file structure causes the at least one processor to generate a particular document based at least in part on the particular unique candidate file structure.

13. The method of clause 8, where the plurality of fields includes a valuation of a vehicle.

Clause 14: A system including:
at least one processor in communication with at least one computer readable storage medium having software instructions stored thereon, where the software instructions, when executed, cause the at least one processor to perform steps to:
   receive, by at least one processor, at least one proposed file structure, where the at least one proposed file structure includes a plurality of fields having a plurality of proposed values;
   input, by the at least one processor, the at least one proposed file structure into an instant structure generation model configured to:
      generate a plurality of proposed value variations by varying each proposed value of the plurality of proposed values within a threshold value range of each field of the plurality of fields; and
      generate a plurality of unique candidate file structures based on each combination of the plurality of proposed value variations;
   access, by the at least one processor, a plurality of accepted historical file structures, each accepted historical file structure including the plurality of fields having a plurality of accepted historical values;
   input, by the at least one processor, the plurality of unique candidate file structures and the plurality of accepted historical file structures into at least one structure similarity machine learning model to output a subset of unique candidate file structures based at least in part on:
      a similarity of the plurality of proposed value variations of each unique candidate file structure to the plurality of fields having a plurality of accepted historical values of each accepted historical file structure; and trained structure similarity machine learning model parameters;
   display, by the at least one processor, a list of the subset of unique candidate file structures via a graphical user interface;
      where the graphical user interface includes a one-click action element for each unique candidate file structure;
      where the one-click action element is configured to, upon a selection of the one-click action element for a particular unique candidate file structure, cause the at least one processor to generate a particular document based at least in part on the particular unique candidate file structure.

15. The system of clause 14, where the displaying the list of the subset of unique candidate file structures includes:
determining, by the at least one processor, a similarity metric associated with each unique candidate file structure of the subset of unique candidate file structures based at least in part on the similarity of the plurality of proposed value variations of each unique candidate file structure;
ranking, by the at least one processor, the list of the subset of unique candidate file structures in an order from highest to lowest similarity to the accepted historical values of each accepted historical file structure based at least in part on the similarity metric associated with each unique candidate file structure; and
displaying, by the at least one processor, the list of the subset of unique candidate file structures in the order.

16. The system of clause 14, where the inputting the plurality of unique candidate file structures into the at least one structure similarity machine learning model to output the subset of unique candidate file structures includes:
calculating, by the at least one processor, for each of the unique candidate file structures, by the at least one structure similarity machine learning model, a percentage likelihood of the unique candidate file structure being accepted.

17. The system of clause 14, where the at least one structure similarity machine learning model includes a random forest classifier.

18. The system of clause 14, further including:
instructing, by the at least one processor, to display the user graphical interface that is configured to enable a manual editing of the particular document.

19. The system of clause 14, where the inputting the at least one proposed file structure into the instant structure generation model includes:
receiving, by the at least one processor, a preferred value for a specified field as input; and
generating, by the at least one processor using the instant structure generation model, the plurality of proposed value variations by varying each proposed value of the plurality of proposed values based at least in part on the preferred value for the specified field.

20. The system of clause 14, where the plurality of fields includes a plurality of data items identifying a valuation of a vehicle.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A method comprising:
receiving, by at least one processor, at least one proposed file structure, wherein the at least one proposed file structure comprises a plurality of fields, wherein at least one populated field of the plurality of fields is populated with at least one fixed value;
inputting, by the at least one processor, the at least one proposed file structure into an instant structure generation model configured to:
generate a plurality of candidate value variations by varying each value of at least one other field of the plurality of fields within a threshold value range of each field of the plurality of fields, the at least one other field being different from the at least one populated field; and
generate a plurality of unique candidate file structures based on each combination of each value of the at least one other field while holding the at least one populated field as fixed;
accessing, by the at least one processor, a plurality of accepted historical file structures, each accepted historical file structure comprising the plurality of fields having a plurality of accepted historical values;
inputting, by the at least one processor, the plurality of unique candidate file structures and the plurality of accepted historical file structures into at least one structure similarity machine learning model to output a subset of unique candidate file structures based at least in part on:
a similarity of the plurality of candidate value variations of each unique candidate file structure to the plurality of fields having a plurality of accepted historical values of each accepted historical file structure, and
trained structure similarity machine learning model parameters; and
displaying, by the at least one processor, a list of the subset of unique candidate file structures via a graphical user interface;
wherein the graphical user interface comprises a one-click action element for each unique candidate file structure;
wherein the one-click action element is configured to, upon a selection of the one-click action element for a particular unique candidate file structure, cause the at least one processor to generate a particular file based at least in part on the particular unique candidate file structure comprising the at least one populated field and the at least one other field of each associated candidate value variation.

2. The method as recited in claim 1, wherein the displaying the list of the subset of unique candidate file structures comprises:
determining, by the at least one processor, a similarity metric associated with each unique candidate file structure of the subset of unique candidate file structures based at least in part on the similarity of the plurality of proposed value variations of each unique candidate file structure;
ranking, by the at least one processor, the list of the subset of unique candidate file structures in an order from highest to lowest similarity to the accepted historical values of each accepted historical file structure based at least in part on the similarity metric associated with each unique candidate file structure; and
displaying, by the at least one processor, the list of the subset of unique candidate file structures in the order.

3. The method as recited in claim 1, wherein the inputting the plurality of unique candidate file structures into the at least one structure similarity machine learning model to output the subset of unique candidate file structures comprises:
calculating, by the at least one processor, for each of the unique candidate file structures, by the at least one structure similarity machine learning model, a percentage likelihood of the unique candidate file structure being accepted.

4. The method as recited in claim 1, wherein the at least one structure similarity machine learning model comprises a random forest classifier.

5. The method as recited in claim 1, further comprising:
instructing, by the at least one processor, to display the user graphical interface that is configured to enable a manual editing of the particular file.

6. The method as recited in claim 1, wherein the inputting the at least one proposed file structure into the instant structure generation model comprises:
receiving, by the at least one processor, a preferred value for a specified field as input; and
generating, by the at least one processor using the instant structure generation model, the plurality of proposed value variations by varying each proposed value of the plurality of proposed values based at least in part on the preferred value for the specified field.

7. The method as recited in claim 1, wherein the plurality of fields comprises a plurality of data items identifying a valuation of a vehicle.

8. A method comprising:
training, by at least one processor, an instant structure generation model to generate a plurality of unique candidate file structures by:
configuring the instant structure generation model to receive as input a candidate file structure that comprises a plurality of fields having a plurality of proposed values and return as output the plurality of unique candidate file structures with a plurality of proposed value variations, wherein the plurality of proposed values comprise at least one populated field having at least fixed value, and at least one other field populated with a respective combination of values of each combination of each value of the at least one other field; and
inputting as training data, by the at least one processor, a plurality of accepted historical file structures into the instant structure generation model, wherein each accepted historical file structure comprises the plurality of fields having at least one historical value;
receiving, by at least one processor, the candidate file structure;
providing, by the at least one processor, the candidate file structure to the trained instant structure generation model; and
receiving, by the at least one processor, the plurality of unique candidate file structures as output from the trained instant structure generation model.

9. The method as recited in claim 8, wherein the inputting as training data, by the at least one processor, the plurality of accepted historical file structures into the instant structure generation model comprises:
pre-processing, by the at least one processor, the plurality of accepted historical file structures into a format expected by the instant structure generation model.

10. The method as recited in claim 8, wherein the configuring the instant structure generation model comprises configuring the instant structure generation model to:
generate a plurality of proposed value variations by varying each proposed value of the plurality of proposed values within a threshold value range of each field of the plurality of fields; and
generate the plurality of unique candidate file structures based on each combination of the plurality of proposed value variations.

11. The method as recited in claim 8, further comprising inputting, by the at least one processor, the plurality of unique candidate file structures into at least one structure similarity machine learning model to output a subset of unique candidate file structures based at least in part on:
a similarity of the plurality of proposed value variations of each unique candidate file structure to the plurality of fields having a plurality of accepted historical values of each accepted historical file structure; and
trained structure similarity machine learning model parameters.

12. The method as recited in claim 8, further comprising displaying, by the at least one processor, a list of a subset of unique candidate file structures via a graphical user interface;
wherein the graphical user interface comprises a one-click action element for each unique candidate file structure;
wherein selection of the one-click action element for a particular unique candidate file structure causes the at least one processor to generate a particular file based at least in part on the particular unique candidate file structure.

13. The method as recited in claim 8, wherein the plurality of fields comprises a valuation of a vehicle.

14. A system comprising:
at least one processor in communication with at least one computer readable storage medium having software instructions stored thereon, wherein the software instructions, when executed, cause the at least one processor to perform steps to:
receive, by at least one processor, at least one proposed file structure, wherein the at least one proposed file structure comprises a plurality of fields, wherein at least one populated field of the plurality of fields is populated with at least one fixed value;
input, by the at least one processor, the at least one proposed file structure into an instant structure generation model configured to:
generate a plurality of candidate value variations by varying each value of at least one other field of the plurality of fields within a threshold value range of each field of the plurality of fields, the at least one other field being different from the at least one populated field; and
generate a plurality of unique candidate file structures based on each combination of each value of the at least one other field while holding the at least one populated field as fixed;
access, by the at least one processor, a plurality of accepted historical file structures, each accepted historical file structure comprising the plurality of fields having a plurality of accepted historical values;
input, by the at least one processor, the plurality of unique candidate file structures and the plurality of accepted historical file structures into at least one structure similarity machine learning model to output a subset of unique candidate file structures based at least in part on:
a similarity of the plurality of candidate value variations of each unique candidate file structure to the plurality of fields having a plurality of accepted historical values of each accepted historical file structure, and trained structure similarity machine learning model parameters; and
display, by the at least one processor, a list of the subset of unique candidate file structures via a graphical user interface;
wherein the graphical user interface comprises a one-click action element for each unique candidate file structure;
wherein the one-click action element is configured to, upon a selection of the one-click action element for a particular unique candidate file structure, cause the at least one processor to generate a particular file based at least in part on the particular unique candidate file structure comprising the at least one populated field and the at least one other field of each associated candidate value variation.

15. The system as recited in claim 14, wherein the displaying the list of the subset of unique candidate file structures comprises:
determining, by the at least one processor, a similarity metric associated with each unique candidate file structure of the subset of unique candidate file structures based at least in part on the similarity of the plurality of proposed value variations of each unique candidate file structure;
ranking, by the at least one processor, the list of the subset of unique candidate file structures in an order from highest to lowest similarity to the accepted historical values of each accepted historical file structure based at least in part on the similarity metric associated with each unique candidate file structure; and
displaying, by the at least one processor, the list of the subset of unique candidate file structures in the order.

16. The system as recited in claim 14, wherein the inputting the plurality of unique candidate file structures into the at least one structure similarity machine learning model to output the subset of unique candidate file structures comprises:
calculating, by the at least one processor, for each of the unique candidate file structures, by the at least one structure similarity machine learning model, a percentage likelihood of the unique candidate file structure being accepted.

17. The system as recited in claim 14, wherein the at least one structure similarity machine learning model comprises a random forest classifier.

18. The system as recited in claim 14, further comprising:
instructing, by the at least one processor, to display the user graphical interface that is configured to enable a manual editing of the particular file.

19. The system as recited in claim 14, wherein the inputting the at least one proposed file structure into the instant structure generation model comprises:
receiving, by the at least one processor, a preferred value for a specified field as input; and
generating, by the at least one processor using the instant structure generation model, the plurality of proposed value variations by varying each proposed value of the plurality of proposed values based at least in part on the preferred value for the specified field.

20. The system as recited in claim 14, wherein the plurality of fields comprises a plurality of data items identifying a valuation of a vehicle.
